(19) United States
(12) Patent Application Publication
(10) Pub. No.: US 2023/0339343 A1
(43) Pub. Date: Oct. 26, 2023

(54) SYSTEMS AND METHODS FOR CHARGING ELECTRIC VEHICLES AND TRAILERS

(71) Applicant: STREAM IT, INC., Austin, TX (US)

(72) Inventors: Lance M. KING, Austin, TX (US); Zach Radkey-Pechacek, Austin, TX (US); Nathan Swanson, Austin, TX (US); Timothy Wulff, Austin, TX (US)

(21) Appl. No.: 18/137,908

(22) Filed: Apr. 21, 2023

Related U.S. Application Data
(60) Provisional application No. 63/334,039, filed on Apr. 22, 2022.

(51) Int. Cl. B60L 53/18; B60L 58/12

(52) U.S. Cl. CPC B60L 53/18; B60L 58/12; B60L 2240/70; B60L 2250/00

(57) ABSTRACT

A system for controlling a charging of at least one of an electric vehicle and a trailer, comprising: a pass-through charging subsystem coupled to the electric vehicle and the trailer; a user interface configured to receive an input associated with a charging instruction; and a controller, comprising: one or more processors; and a memory storing software instructions that, when executed by the one or more processors, cause the one or more processors to: direct electricity from a charger through the pass-through charging system such that the at least one of the electric vehicle and the trailer is charged in accordance with the charging instruction.

### CROSS REFERENCE TO RELATED APPLICATIONS

This application claims priority to U.S. Provisional Pat. Application Serial No. 63/334,039, filed on Apr. 22, 2022, which is incorporated by reference herein in its entirety.

### BACKGROUND

### 1. Field

The field of the invention is electric vehicles, trailers, and charging of electric vehicles and trailers.

### 2. Related Art

It can be difficult or even impossible to charge an electric vehicle when a trailer (e.g., nonautomotive vehicle, transport container, vehicle designed to serve as a temporary dwelling or place of business that are configured to be towed by a vehicle) is hitched (connected) to the electric vehicle. The difficulty can be due to, for example, the location of the charge port in most vehicles and the location of the charger. There is no standardized location on the vehicle for the charging port. For example, some vehicles have the charging port on the front center of the vehicle, others have the Level I charging port on the passenger side front fender with the Level II and III charger ports on the driver side front fender, while all Tesla vehicles to date have had the port on the driver side rear fender.

Further complicating matters the charging station position is not standardized relative to the parking stalls. Some charging stalls have it at the front of the stall on the left, right, or center while other charging stalls have the charging station located in the middle of the parking stall on either the left or right side of the parking stall, but it can also be located at the back end of the stall.

If a vehicle has a trailer attached it is extremely difficult to charge because the charging cables are very short and can’t reach past the trailer to the vehicle. As a result, the vehicle is forced to park perpendicular to the parking space and thereby occupy many parking/charging stalls to get the cable to reach, or disconnect the trailer to charge and then reconnect when charging is completed. This is time consuming, inconvenient (especially in inclement weather), and increases the risk of errors which can lead to accidents and fatalities (if trailer wiring connectors, chains, or safety devices are not attached or are improperly attached) when frequently disconnecting and reconnecting the trailer.

### SUMMARY

The pass through charging systems and methods of the disclosure advantageously allows a user to connect a charger to the trailer, and pass the charge on to the electric vehicle. In some aspects, the trailer can also be charged, e.g., simultaneously or sequentially. Contemplated systems can optionally smart charge both the vehicle and the trailer. For example, when charging begins and the state of charge (SoC) of the vehicle is at its lowest (or is low), all of the electricity can be passed on to the vehicle to charge it as quickly as possible. As the vehicle battery’s SoC increases, for example, beyond 50% or another threshold, the charge rate can slow below a maximum rate, and the trailer can be charged with the excess charge capacity without increasing the charge time for the vehicle. In some aspects, a user can select which battery to fill up first (e.g., trailer or vehicle), and then charge the other.

Other advantages and benefits of the disclosed system and methods will be apparent to one of ordinary skill with a review of the following detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The details of embodiments of the present disclosure, both as to their structure and operation, can be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example electric vehicle being charged through a charging of the trailer;

FIG. 4 illustrates connectors for various charging standards that can be used with the embodiments described herein; and

FIG. 5 Is a chart illustrating various charging curves that can result from the embodiments described herein.

### DETAILED DESCRIPTION

After reading this description, it will become apparent to one skilled in the art how to implement the various alternative embodiments and alternative applications described herein; however, although various embodiments will be described herein, it is understood that these embodiments are presented by way of example and illustration only, and not limitation. As such, this detailed description of various embodiments should not be construed to limit the scope or breadth of the appended claims. In some instances, well-known structures and components are shown in simplified form for brevity of description. Some of the surfaces have been left out or exaggerated for clarity and ease of explanation.

### System Overview

### 1.1 Infrastructure

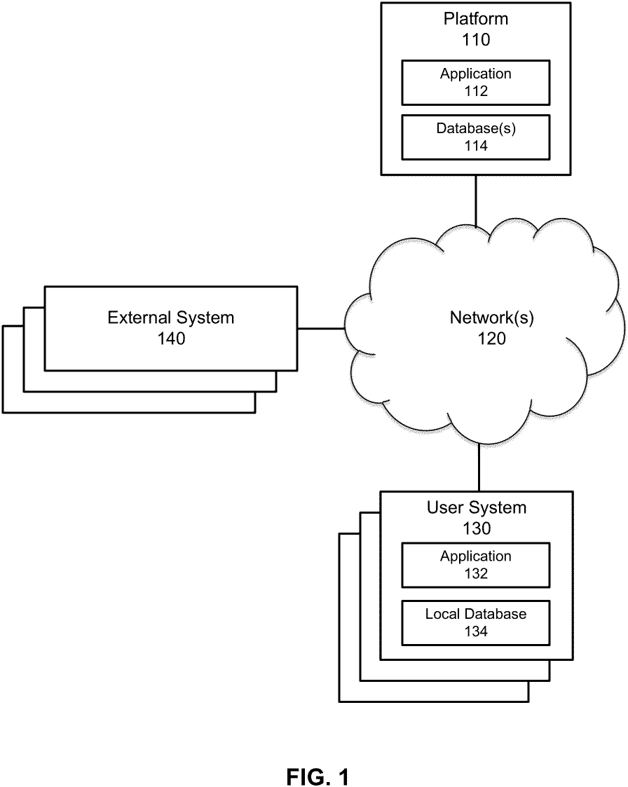

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120, or may be entirely implemented on the loopback (e.g., localhost) interface. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases. In addition, communication between any of these systems, for example, platform 110, user systems 130, and/or external system 140, may be entirely implemented on the loopback (e.g., localhost) interface.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. Each user system 130 may comprise or be communicatively connected to a client application 132 and/or one or more local databases 134. While user system 130 and platform 110 are shown here as separate devices connected by a network 120. User system 130 may comprise an application 132 that may comprise one portion of a distributed cloud-based system that integrates with platform 110, for example, using a multi-tasking OS (e.g., Linux) and local only (localhost) network addresses.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, or may be entirely implemented on the loopback (e.g., localhost) interface, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST, GET, and PUT request supported by HTTP, via FTP, proprietary protocols, requests using data encryption via SSL (HTTPS requests), and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

While platform 110, user systems 130, and external systems 140 are shown as separate devices communicatively coupled by network 120, each of the devices shown as platform 110, user systems 130, and external systems 140 may be implemented on one or more devices, and/or one or more of platform 110, user systems 130, and external systems 140 may be implemented on a single device.

### 1.2 Example Processing Device

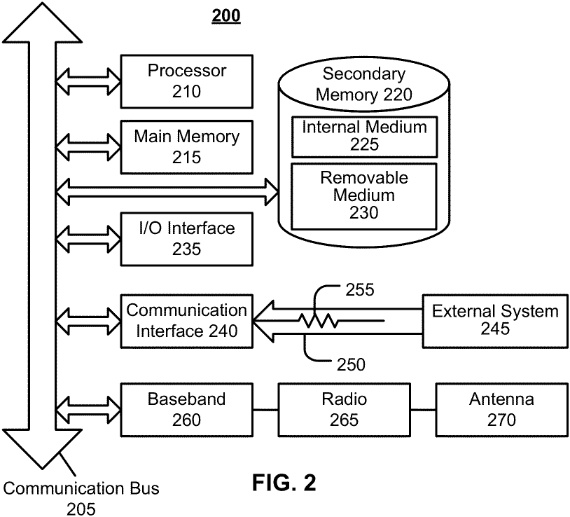

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magnetooptical drive, and/or the like.

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

### 1. Process Overview

Embodiments of processes for charging at least one of a vehicle and a trailer will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

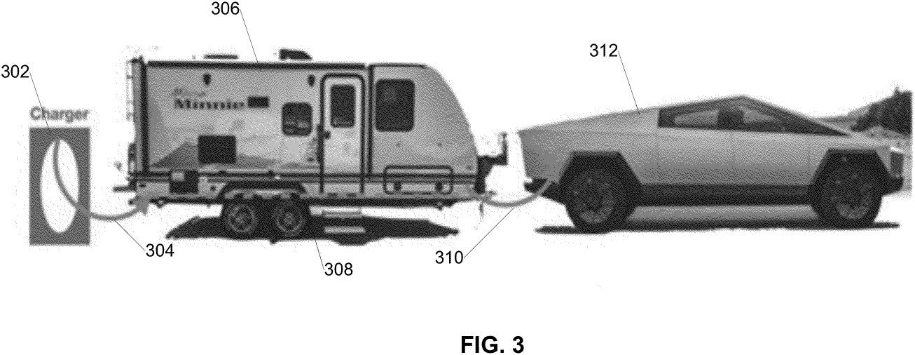

In some aspects, a system for controlling a charging of at least one of an electric vehicle and a trailer is provided. The system can comprise a pass-through charging subsystem, for example, as shown in FIG. 3. Thus, a charger system 302 can comprise a charging extension 304 with a connector, not shown but described in more detail below, configured to plug into a charging port on trailer 306 in this case. Trailer 306 can then comprise extension 308 that runs along or through trailer 306 and that also includes an extension 310 with a connector (not show) configured to connect with the charging port (not shown) on vehicle 312.

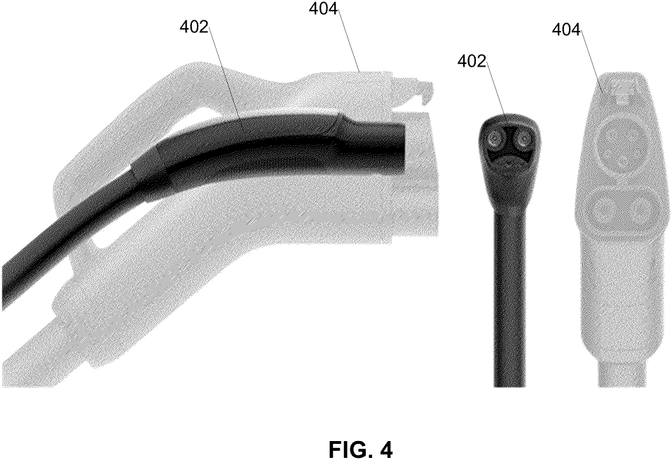

The connectors can be configured to conform to various standards. While there are several different standards available to choose from, only two currently make sense in North America: the Combined Charging System (CCS) developed by European auto manufacturers, and the North American Charging Standard (NACS) developed by Tesla and made open source in 2022. NACS is currently the most popular in North America both by number of charging stations 302 and number of vehicles configured to use the standard. Further, NACS is smaller, lighter, costs less, is significantly more reliable, can be used for AC (alternating current) charging at Level I with 110 v and Level II at 220 v as well as DC fast charging at Level III, and can accommodate twice the power of CCS (up to 1 MW). FIG. 4 illustrates the differences between a NACS connector 402 and a CCS connector 404.

Thus, while pass through charging can be utilized with any connector standard the NACS standard can be preferred, especially in North America.

In a simple embodiment, the extension 308 can have a port configured to interface with the connector on charging station extension 304. Thus, the driver can manually choose to plug extension 304 into trailer 306 to charge trailer 306, or into extension 308 in order to charge vehicle 312, which would also require plugging extension 310 into the charging port on vehicle 312.

Alternatively, in a slightly more complex embodiment, the charging port on trailer 306 can couple with an interface that allows the charging to be switched between the trailer 306, via its normal charging system, and vehicle 312 via extension 308/310. A user interface (not shown) can be included on or within trailer 306 that allows the driver to switch charging between the trailer 306 and the vehicle 312. The user interface can be a simple mechanical interface such as a switch, or button(s) that will switch the charging between the two.

In an even more complex embodiment, the user interface and charging interface can be more complex and configured to receive an input associated with a charging instruction, e.g., to charge the vehicle then the trailer, to charge the trailer then the vehicle, to charge only the vehicle, to charge only the trailer, or to simultaneously charge the vehicle and the trailer. Thus, the user interface may comprise a series of inputs that can be selected, such as multiple buttons, or switch settings, or even a touch screen that allow various charging options to be selected.

The user interface can thus be interfaced, e.g., via I/O interface 235, with a system 200, comprising one or more processors 210, and a memory, e.g., memory 215 storing software instructions that, when executed by the one or more processors 210, cause the one or more processors 210 to direct electricity from a charger through the pass-through charging system such that the at least one of the electric vehicle and the trailer is charged in accordance with the charging instructions.

In certain embodiments, charging of the tow vehicle 312 can be prioritized such that it charges as quickly as it can accept a charge. If the tow vehicle 312 can take 100% of what the charging system can provide, then it will receive all the charge. However, as the vehicle charging speed slows, i.e., ramps down, as its batteries approach their storage capacity, the excess charging capacity can then be used to charge the trailer’s (306) batteries. If the charging system can provide a faster charge than the vehicle 312 can accept, then the vehicle 312 and trailer 306 charging can begin immediately.

This way, it would take little to no extra time to charge the trailer 306 battery because it will ramp up charging as the vehicle 312 ramps down. Or, in the case where the charging system can provide more capacity than the vehicle 312 can accept, the vehicle 312 can charge at its maximum rate and the trailer 306 will get as close to its maximum rate as the system will aloe, and the vehicle 312 and trailer 306 can both ramp down independently as needed. This makes charging easier and quicker while eliminating the need to disconnect/reconnect the trailer 306.

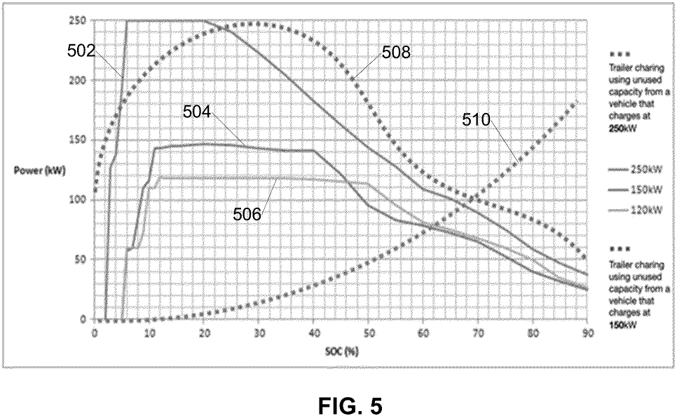

The graph of FIG. 5 illustrates how the trailer 306 can charged using unused capacity for vehicle charging, depending on the charging level. Curves 502, 504, and 506 illustrating the vehicle charging levels of 250 kW, 150 kW, and 120 kW, respectively. Curve 508 then illustrates the trailer charging, when the vehicle charging level is 250 kW, and curve 510 illustrates the trailer charging, when the vehicle charging level is 120 kW.

With conventional charging systems, in order for simultaneous charging, the vehicle and trailer inverters would need to charge at the same rate.

### 2.1 Communication/Coordination

Communication between the vehicle 312 and trailer 306 charging systems, and the trailer 306 charging system and charger 302 can use the control pilot (CP) contact (also known as the Power Line Communicator or PLC) for Basic Signaling (BS) by way of pulse width modulation (PWM)-all in accordance with IEC 61851-1.

The charge station 302 typically uses PWM initially to communicate the maximum available current from the charge station 302. It then establishes high-level communication (HLC). HLC is based on ISO/IEC15118 series and DIN SPEC 70121, also called the “Plug and Charge” standard because it doesn’t require any further interaction with a control panel or a mobile app to activate. This ISO 15118 specification supports V2G, or vehicle to grid, charging and discharging of electric vehicles so a vehicle can also be used to power a home during a power outage as well as being charged by it when power is available.

The charging system described above can be configured to act as a “man in the middle” and capture the charging information including volts, amps/rate desired by the vehicle, along with the account information for automatic billing, and then add what the trailer can accept to that up to the limits of the charging system. The trailer would then continue to monitor and adjust as the vehicle’s needs change. In other words, the trailer captures the information from the vehicle that would normally be passed to the charger, combines that with the data from the trailer to provide the single set of charging instructions to the charger that it is expecting to see. Alternatively, the trailer can pass the charging data from the vehicle to the charger and allow it to charge normally. Then when the vehicle charge is completed, the trailer can virtually “disconnect” the vehicle from the charger when charging is complete and then start a new charging session for the trailer. While this method would not allow the charging of both vehicles simultaneously, it might be necessary if the vehicle and the trailer can’t be charged at the same rate or if the total time required to charge both vehicles would be faster to charge one at its maximum rate and then charge the other rather than synchronizing them to both charge at the same rate. For example, if the vehicle can charge at 800 V but the trailer can only charge at 400 V they could both be charged simultaneously at 400 V, or the vehicle could be charged at 800 V and when it has completed its charge the trailer can then be charged at 400 V.

In some aspects, a system for charging at least one of an electric vehicle and a trailer is provided. The system can comprise a pass-through charging subsystem coupled to the electric vehicle and the trailer. The system can comprise a controller, comprising one or more processors, and a memory storing software instructions that, when executed by the one or more processors, cause the one or more processors to direct electricity from a charger through the pass-through charging system such that the at least one of the electric vehicle and the trailer is charged in accordance with a charging instructions. In some aspects, the software instructions, when executed by the one or more processors, can cause the one or more processors to one or more of (a) determine a charged amount of the vehicle, (b) determine a charged amount of the trailer, (c) obtain data associated with a charged amount of the vehicle, (d) obtain data associated with a charged amount of the trailer, (e) determine a charging instruction based at least in part on at least one of data obtained from a sensor, data obtained from one or more databases, (a), (b), (c) and (d), and (f) direct electricity from a charger through the pass-through charging system such that the at least one of the electric vehicle and the trailer is charged in accordance with the charging instruction.

In some aspects, a method of charging an electric vehicle by connecting a vehicle charger to a trailer coupled to the electric vehicle is provided. In some aspects, a pass-through charging system of or coupled to a trailer is provided. The pass-through charging system can be configured to direct electricity from a charger to an electric vehicle. In some aspects, a user can connect a charger to the trailer charge port, and pass the charge on to the electric vehicle, for example, via a pass-through charging system of or coupled to a trailer. In some aspects, the trailer can also be charged, e.g., simultaneously or sequentially. In some methods, a charge of both the vehicle and the trailer is contemplated. For example, when charging begins and the state of charge (SoC) of the vehicle is at its lowest (or is low), all of the electricity can be passed on to the vehicle to charge it as quickly as possible. As the vehicle battery’s SoC increases, for example, beyond 50% or another threshold, the charge rate can slow below a maximum rate, and the trailer can be charged with the excess charge capacity without increasing the charge time for the vehicle. In some aspects, a user can select which battery to fill up first (e.g., trailer or vehicle), and then charge the other.

Thus, specific examples of systems and methods for charging at least one of a vehicle and a trailer have been disclosed. The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Reference throughout this specification to “an embodiment” or “an implementation” means that a particular feature, structure, or characteristic described in connection with the embodiment is included in at least one embodiment or implementation. Thus, appearances of the phrases “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Certain numerical values and ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B’s, multiple A’s and one B, or multiple A’s and multiple B’s.

All structural and functional equivalents to the components of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for controlling a charging of at least one of an electric vehicle and a trailer, comprising:
a pass-through charging subsystem coupled to the electric vehicle and the trailer;
a user interface configured to receive an input associated with a charging instruction; and
a controller, comprising:
one or more processors; and
a memory storing software instructions that, when executed by the one or more processors, cause the one or more processors to:
direct electricity from a charger through the pass-through charging system such that the at least one of the electric vehicle and the trailer is charged in accordance with the charging instruction.

2. A method of charging an electric vehicle by connecting a vehicle charger to a trailer coupled to the electric vehicle.

3. A pass-through charging system coupled to a trailer, wherein the pass-through charging system is configured to direct electricity from a charger to an electric vehicle.

4. A system for controlling a charging of at least one of an electric vehicle and a trailer, comprising:
a pass-through charging subsystem coupled to the electric vehicle and the trailer; and
a controller, comprising:
one or more processors; and
a memory storing software instructions that, when executed by the one or more processors, cause the one or more processors to one or more of:
(a) determine a charged amount of the vehicle;
(b) determine a charged amount of the trailer;
(c) obtain data associated with a charged amount of the vehicle;
(d) obtain data associated with a charged amount of the trailer;
(e) determine a charging instruction based at least in part on at least one of data obtained from a sensor, data obtained from one or more databases, (a), (b), (c) and (d); and
(f) direct electricity from a charger through the pass-through charging system such that the at least one of the electric vehicle and the trailer is charged in accordance with the charging instruction.

5. The system of claim 4, further comprising a user interface configured to receive a user input, and wherein the user input is the charging instruction.
